(19) United States
(12) Patent Application Publication
(10) Pub. No.: US 2008/0171194 A1
(43) Pub. Date: Jul. 17, 2008

(54) Heat dissipation structures

(75) Inventors: Tse-Hao Ko, Taichung (TW); Wen-Shyong Kuo, Taichung (TW); Hsin-Fang Lu, Taichung (TW); Su-Ching Yen, Taichung (TW); Yi-Lung Chiang, Taichung (TW)

Correspondence Address: VENABLE LLP, P.O. BOX 34385, WASHINGTON, DC, 20043-9998, US

(73) Assignee: FENG CHIA UNIVERSITY, Taichung (TW)

(21) Appl. No.: 11/806,207

(22) Filed: May 30, 2007

(30) Foreign Application Priority Data
Jan. 17, 2007 (TW) 096101795

(51) Int. Cl. B32B 5/16

(52) U.S. Cl. 428/328

(57) ABSTRACT

A heat dissipation structure is provided. The heat dissipation structure comprises a carbon substrate and a metal layer which at least partially covers the sidewall of the carbon substrate. The metal layer covering the carbon substrate can not only increase the heat dissipation efficiency of the carbon substrate but can also eliminate the short circuiting of the elements when dust accumulates on them.

This application claims priority to Taiwan Patent Application No. 096101795 filed on 17 Jan. 2007.

### CROSS-REFERENCES TO RELATED APPLICATIONS

Not applicable.

### FIELD OF THE INVENTION

The subject invention relates to a heat dissipation structure with high heat dissipation efficiency, especially for a carbon substrate coated with a metal layer.

### BACKGROUND OF THE INVENTION

The recent development of electronic devices, such as liquid crystal displays (LCDs), plasma televisions, light emitting diodes, central processing units (CPUs) of computers, medical equipments, office equipments, and communication units, have been gearing towards the miniaturization. However, miniaturizing electronic devices complicates circuit design. Moreover, the heat that is generated by these electronic devices will need to be dissipated more efficiently.

To spread the generated heat efficiently, many heat dissipation methods, elements and materials have been proposed. Conventional electronic devices and similar devices have focused on improving the heat dissipation module. All of said heat dissipation modules use metal sheets with a high thermal conductivity, e.g., aluminum (thermal conductivity coefficient of 226 W/mK), copper (thermal conductivity coefficient of 385 W/mK) or other metal alloy, as the heat dissipation material. These heat dissipation modules compare the temperature of the outside air with the temperature of the heat on the element's surface to dissipate the heat energy when needed. Thus, the temperature can be decreased during the operation of the electronic element.

The mass of the metal material, e.g., copper, aluminum, or an alloy thereof, is, however, problematic for use in heat dissipation sheets. For example, the density of pure copper is 8.96 g/cm³ and that of pure aluminum is 2.70 g/cm³. Particularly, in the heat dissipation system of most circuit boards, it is necessary to deposit a plurality of heat dissipation structures to dissipate the heat energy generated by each element of the circuit board. However, when the circuit board contains many heat dissipation sheets made of metal materials, the metal net weight not only increases the total weight of the circuit board, but also increases the possibility of the board cracking due to the heavy load. Furthermore, to maximize the heat dissipation benefit, generally, the heat dissipation structure is completely connected with the electronic element. In this aspect, most of the electronic elements per se are also made of metals or other relatively rigid materials (such as alumina or ceramic materials), and these materials are irregular and deformability. Therefore, a relatively high pressure riveting is needed to allow the metal heat dissipation sheet to be completely connected to the electronic element. Unfortunately, the high pressure riveting can easily damage the electronic elements and thus, cause problems.

To address the problem with using metal heat dissipation sheets, graphite material has been substituted for use as the heat dissipation sheet. Graphite is lightweight, cheaper and also has a good heat dissipation efficiency. U.S. Pat. No. 5,831,374, assigned to Makoto Morita et al., discloses the use of a high-orientation graphite film to dissipate the heat in a plasma display panel. In U.S. Pat. No. 6,482,520, assigned to Jing Wen Tzeng, the exfoliated graphite particles were compressed to form a sheet for use as a heat spreader. The spreader can rapidly transfer the heat energy produced by the electronic elements to dissipate the heat. Advanced Energy Technology Inc. located in Lakewood, Ohio, U.S.A. has also commercially sold the aforementioned materials using the trade name eGRAF®. The product is widely used in thermal spreaders and heat sinks.

In U.S. Pat. No. 6,482,520, the graphite sheet has a thermal conductivity coefficient of 7 W/mK in a direction perpendicular to the carbon layers (also called the c direction) and 150 to 200 W/mK in a direction parallel to the carbon layer (also called the a direction). Moreover, Advanced Energy Technology Inc. contends that the graphite sheet product eGRAF® made by natural graphite flakes can have a thermal conductivity coefficient of 7 to 12 W/mK in a direction perpendicular to the carbon layers and 20 to 200 W/mK in a direction parallel to the carbon layer using different manufacturing processes. However, although the graphite sheet has excellent heat dissipation efficiency in the direction parallel to the carbon layer, it is not as efficient in the direction perpendicular to the carbon layers. In addition, the graphite sheet is susceptible to the falling of dust. When the graphite sheet is used in electronic elements, it is very likely that the falling of dust will short circuit the elements.

With the development of 3C industrial technology, it has become increasingly important to find a way to efficiently and rapidly dissipate the heat generated by electronic elements. As a result, there is a need for finding a material that is capable of rapidly dissipating heat.

### SUMMARY OF THE INVENTION

The subject invention provides a heat dissipation structure, comprising: a carbon substrate, and a metal layer, which at least partially covers a sidewall of the carbon substrate.

### BRIEF DESCRIPTION OF THE DRAWINGS

FIG. 1 is a schematic drawing of the heat dissipation structure according to one embodiment of the subject invention.

FIG. 2 is a schematic drawing of the heat dissipation structure according to another embodiment of the subject invention.

### DESCRIPTION OF THE INVENTION

The carbon substrate of the heat dissipation structure of the subject invention comprises a carbonaceous component selected from a group consisting of: carbon, activated carbon, graphite, and a combination thereof. The carbon substrate should preferably comprise graphite. The carbonaceous component of the carbon substrate is generally in the form of powder, particle, sheet, fiber, or fabric. In one preferred embodiment, the graphite material is used as the carbon substrate. The graphite material can be selected from a group consisting of, for example, but not limited to: natural graphite (such as natural flake graphite and exfoliated graphite), artificial graphite, and a combination thereof. The carbon substrate should preferably also comprise natural graphite flakes and/or exfoliated graphite. The carbon for use in the carbon substrate of the subject invention comprises: diamond carbon powder, a carbon nanotube, a carbon fiber, a carbon black, and a combination thereof. The carbon fiber can be selected from a group consisting of: fringed carbon fiber, vapor-grown carbon fiber, and a combination thereof.

In addition to the carbonaceous component, the carbon substrate can optionally contain other materials with high thermal conductivity. The material with a high heat conductivity can be selected from a group consisting of, for example, but not limited to: Cu, Al, Ni, Au, Ag, an alloy of the foregoing metals, silicon carbide, boron nitride, and a combination of the foregoing components. The optional material with a high thermal conductivity can be in power, filament fabric or fiber form. Based on the total volume of the carbon substrate, the amount of the high thermal conducing material can be about 0.05 to 20 vol. %.

According to the subject invention, the carbonaceous material and the optional high thermal conducing material can be compressed into the desired shape. For example, when the carbon substrate of the subject invention is added with a metal material that has a high thermal conductivity, such as Cu, Al, Ni, Au, and Ag, the carbon substrate can be shaped using squeeze casting or powder metallurgy. With squeeze casting, the metal is heated and melted and then poured into a pre-shaped material. Afterwards, the metal is compressed until it is solidified. Moreover, with powder metallurgy, the metal powder and the particles (or flakes or fringes) of the carbonaceous component, such as graphite, are rapidly mixed, pressed, and air-ejected, and then subjected to the final solidification using a thermal processing manner, such as extruding swaging or calendaring. The carbon substrate can be in any of the following forms, sheet, block, squamose or corrugation, but is not limited to any particular form.

The density of the shaped carbon substrate changes as materials are added. However, without other components (i.e., the carbon substrate substantially consists of the carbonaceous material only), the density of the carbon substrate normally ranges from 0.02 to 2.25 g/cm³, preferably from 0.1 to 2.25 g/cm³, and more preferably from 1.5 to 2.25 g/cm³.

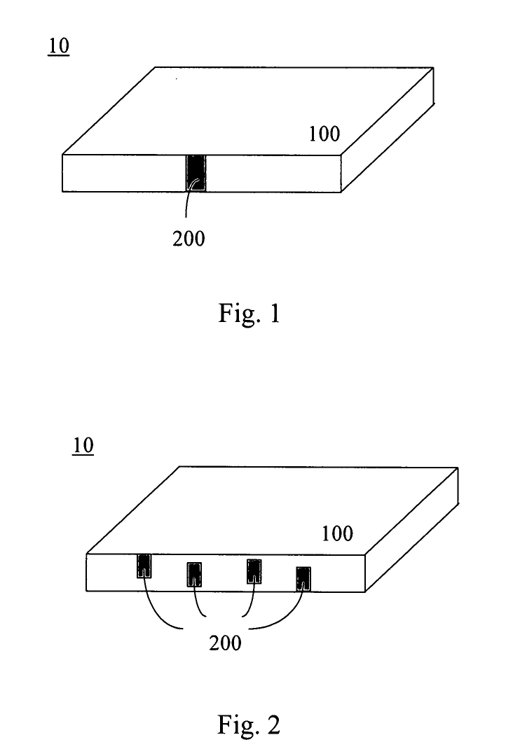

The metal layer in the heat dissipation structure of the subject invention is provided by using any metal material for heat dissipation, e.g., Cu, Al, Ni, Au, Ag, an alloy of the foregoing metals, or a combination thereof. In one embodiment, Cu is used as the metal layer. The metal layer needs to at least partially cover the sidewall of the carbon substrate. As shown in FIG. 1, a heat dissipation structure 10 comprises a carbon substrate 100 and a metal layer 200, wherein the metal layer 200 is partially coated on one sidewall of the carbon substrate 100. The metal layer 100 can also be non-continuously coated on the sidewall of the carbon substrate 100, as shown in FIG. 2. Moreover, the metal layer-coated region on the sidewall of the carbon substrate can have an uneven edge and be different from those illustrated in FIGS. 1 and 2. The metal layer should preferably be coated on the entire surface of one sidewall of the carbon substrate. It is best if the whole surface of the carbon substrate can be coated with the metal layer. Although the thickness of the metal layer is not critical to the subject invention, it does factor into weight and costs. The metal layer typically has a thickness ranging from 0.001 μm to 1 mm, preferably from 0.01 μm to 0.5 mm.

The metal layer can be coated on the carbon substrate surface using any suitable electrochemical method, such as electroforming, electroplating, or electroless plating. However, the electroplating method is the cheapest and most convenient to coat the metal layer onto the carbon substrate. As mentioned above, the carbon substrate coated with a metal layer on its partial sidewall is sufficient enough to provide a heat dissipation structure exhibiting excellent thermal conductivity in not only the parallel direction but also the perpendicular direction. In this aspect, the carbon substrate can be directly placed into an electroplating solution for conducting the electroplating to obtain a carbon substrate entirely coated with a metal layer. If a carbon substrate partially coated with a metal layer is desired, a pre-treatment such as applying an oily gel to the portion which is not desired to be coated needs to be conducted before the placement of the substrate into an electroplating bath. As the electroplating is completed, the oily gel on the carbon substrate is then taken off with the use of a solvent. Thereafter, a carbon substrate partially coated with a metal layer is produced.

Since the sidewall of the carbon substrate in the heat dissipation structure of the subject invention is coated with the metal layer, the thermal conductivity in the perpendicular direction is improved. Moreover, if the metal layer is coated on the whole surface of the carbon substrate, there would not be a falling of dust, and thereby, preventing short circuit. Furthermore, it has been found that when a manufacturing method involves compressing to prepare the carbon substrate required in the heat dissipation structure of the subject invention, the heat dissipation structure substantially has superior thermal conductivity in a parallel direction to that provided by the prior heat dissipation carbonaceous materials. In other words, the heat dissipation structure of the subject invention not only is lightweight and cheap, but it also provides better heat dissipation efficiency and prevents the aforementioned drawbacks.

Because the substrate and the metal layer of the heat dissipation structure of the subject invention have electrical conductivity, an insulating layer such as resin and rubber can be optionally provided on one or more surfaces of the heat dissipation structure as desired. This can be done by a couple of process, sticking or coating, to bind the insulating layer and the heat dissipation structure.

The heat dissipation structure of the subject invention can be used in many heating devices to provide heat dissipation. For example, the heat dissipation structure is bound to a heat generating source such as light emitting diodes, various displays (e.g., plasma display or liquid crystal display), central processing units of computers, or various lamps by a heat-transfer gel to attain the purpose of heat dissipation.

### EXAMPLES

The subject invention is further illustrated by the following embodiments. The testing equipments and methods are described below:

(A) Density measurement
Equipment: Electronic Densimeter (Mode: MD-200S), MIRAGE, Japan
Method: The density (p) is measured using Archimedes principle.

(B) Measurement of thermal conductivity coefficient
Equipment: Mode Micro30 produced by HOLOMETRIX Corp.
Method: According to ASTM 1461 C714, a laser light beam is emitted on the bottom surface of a sample and then the surface temperature variation on the opposite surface is detected. Thus, the thermal diffusion coefficient (α) and the thermal conductivity coefficient (k) can be obtained. The equation for calculating the thermal conductivity coefficient (k) is expressed as follows:

k=(α)(ρ)(Cₚ)
k: thermal conductivity coefficient (W/mK)
α: thermal diffusion coefficient (cm²/s)
ρ: bulk density (g/cm³)
Cₚ: specific heat (J/g.K)

### Example 1

Particular flake graphite (produced by INternational CArbide Technology Co., Ltd., No. CA002) was used as the raw material and was compressed to form a sheet with a thickness of 2.97 mm and a density of 2.211 g/cm³. Then, the sheet was electroplated in 1M CuSO₄ aqueous solution with a current density of 100 mA/cm² for 300 seconds to form a copper layer on its surface. The thickness of the copper layer was about 1 μm.

The thermal conductivity coefficients of the graphite sheet that were not electroplated with the copper layer (C1) and copper-electroplated graphite sheet (E1) in both the direction parallel to the carbon layers and the direction perpendicular to the carbon layers were tested. The testing results are listed in Table 1.

TABLE 1

| | | Thermal | Thermal |
|---|---|---|---|
| | | conductivity | conductivity |
| | Density | coefficient*¹ | coefficient*² |
| Sample | (g/cm³) | (W/mK) | (W/mK) |
| C1 | 2.211 | 343.5 | 18.3 |
| E1 | 2.214 | 401.5 | 21.8 |

*¹direction parallel to the carbon layers
*²direction perpendicular to the carbon layers

Table 1 shows that the flake graphite sheet has a thermal conductivity coefficient of 343.5 W/mK in the direction parallel to the carbon layers and 18.3 W/mK in the direction perpendicular to the carbon layers. The copper-electroplated flake graphite sheet has thermal conductivity coefficients of 401.5 W/mK and 21.8 W/mK in the parallel and perpendicular directions, respectively. The copper-electroplated flake graphite sheet also exhibited 17% and 19% more heat dissipation in the direction parallel to the carbon layers and the direction perpendicular to the carbon layers, respectively.

### Example 2

The flake graphite (produced by INternational CArbide Technology Co., Ltd., No. CA002) was placed in a mixture solution comprising 95% concentration of H₂SO₄ and 70% concentration of HNO₃ in a volume ratio of 3:2.5 for 15 minutes, and then washed with water until the pH of the graphite material reached 5 to 6. Afterwards, the graphite was dried at 70° C. for 24 hours and then heat treated under a nitrogen gas atmosphere for 5 seconds to produce exfoliated graphite.

The resulting exfoliated graphite had a thickness of 2.97 mm and a density of 1.750 g/cm³. The electroplating was conducted in 1M CuSO₄ aqueous solution with a current density of 100 mA/cm² for 400 seconds to form a copper layer on the sheet surface. The thickness of the copper layer was 1.5 μm. The thermal conductivity coefficients of the graphite sheet that were not electroplated with copper (C2) and copper-electroplated graphite sheet (E2) both in the direction parallel to the carbon layers and in the direction perpendicular to the carbon layers were tested. The testing results are listed in Table 2.

TABLE 2

| | | Thermal | Thermal |
|---|---|---|---|
| | | conductivity | conductivity |
| | Density | coefficient*¹ | coefficient*² |
| Sample | (g/cm³) | (W/mK) | (W/mK) |
| C2 | 1.750 | 276.3 | 9.05 |
| E2 | 1.759 | 340.6 | 10.4 |

*¹direction parallel to the carbon layers
*²direction perpendicular to the carbon layers

Table 2 shows that the exfoliated graphite sheet has a thermal conductivity coefficient of 276.3 W/mK in the direction parallel to the carbon layers and 9.5 W/mK in the direction perpendicular to the carbon layers. The copper-electroplated exfoliated graphite sheet has a thermal conductivity coefficient of 340.6 W/mK and 10.4 W/mK in parallel and perpendicular directions, respectively. The copper-electroplated exfoliated graphite sheet exhibited 23% and 10% more heat dissipation in the direction parallel to the carbon layers and the direction perpendicular to the carbon layers, respectively.

The above two examples demonstrate that the use of a carbonaceous material as the raw material and a simple metal coating process can increase the whole heat dissipation efficiency of the substrate provided by the carbonaceous material.

The above examples are only intended for illustrating the embodiments of the subject invention and showing its technical features, not for limiting the scope of protection of the subject invention. Any arrangements of changes or equivalents that can be easily accomplished by persons having ordinary skill in the art are within the scope of the subject invention. The scope of protection of the subject invention is based on the claims attached.

What is claimed is:

1. A heat dissipation structure, comprising:
a carbon substrate, and
a metal layer, at least partially covering a sidewall of the carbon substrate.

2. The heat dissipation structure of claim 1, wherein the metal layer at least covers the entire surface of a sidewall of the carbon substrate.

3. The heat dissipation structure of claim 1, wherein the metal layer covers the entire surface of the carbon substrate.

4. The heat dissipation structure of claim 1, wherein the carbon substrate comprises a carbonaceous component selected from a group consisting of: a carbon, an activated carbon, a graphite, and a combination thereof.

5. The heat dissipation structure of claim 4, wherein the carbonaceous component is in a form of a powder, a particle, a sheet, a fiber, or a fabric.

6. The heat dissipation structure of claim 4, wherein the carbon is selected from a group consisting of: a diamond carbon powder, a carbon nanotube, a carbon fiber, a carbon black, and a combination thereof.

7. The heat dissipation structure of claim 6, wherein the carbon fiber is selected from a group consisting of: a fringed carbon fiber, a vapor-grown carbon fiber, and a combination thereof.

8. The heat dissipation structure of claim 4, wherein the graphite is selected from a group consisting of: a natural graphite, an artificial graphite, and a combination thereof.

9. The heat dissipation structure of claim 8, wherein the natural graphite is selected from a group consisting of: a natural flake graphite, an exfoliated graphite, and a combination thereof.

10. The heat dissipation structure of claim 1, wherein the carbon substrate is in a form of a sheet, a block, a squamose, or a corrugation.

11. The heat dissipation structure of claim 1, wherein the carbon substrate is substantially free of a component other than the carbonaceous material and has a density of from 0.02 to 2.25 g/cm³.

12. The heat dissipation structure of claim 11, wherein the carbon substrate has a density of 0.1 to 2.25 g/cm³.

13. The heat dissipation structure of claim 4, wherein the carbon substrate further comprises a material with a high thermal conductivity.

14. The heat dissipation structure of claim 13, wherein the material with a high thermal conductivity is selected from a group consisting of: Cu, Al, Ni, Au, Ag, an alloy of the foregoing metals, silicon carbide, boron nitride, and a combination of the foregoing components.

15. The heat dissipation structure of claim 14, wherein the material with a high thermal conductivity is in a form of a powder, a fabric, a fiber, or a filament.

16. The heat dissipation structure of claim 13, wherein the amount of the material with a high thermal conductivity is from 0.05 to 20 vol. %, based on the total volume of the carbon substrate.

17. The heat dissipation structure of claim 1, wherein the metal layer comprises a component selected from a group consisting of: Cu, Al, Ni, Au, Ag, an alloy of the foregoing metals, and a combination of the foregoing components.

18. The heat dissipation structure of claim 17, wherein the metal layer comprises Cu.

19. The heat dissipation structure of claim 1, wherein the metal layer has a thickness of from 0.001 μm to 1 mm.

20. The heat dissipation structure of claim 1, further comprising an insulating layer at least located on a selected region of the structure surface.
